(19) United States
(12) Patent Application Publication
(10) Pub. No.: US 2010/0321404 A1
(43) Pub. Date: Dec. 23, 2010

(54) METHOD AND DEVICE FOR DISPLAYING AN X-RAY IMAGE RECORDED IN THE COURSE OF MAMMOGRAPHY

(76) Inventors: Daniel Fischer, Erlangen (DE); Wilhelm Hanke, Ruckersdorf (DE); Thomas Mertelmeier, Erlangen (DE)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/445,999

(22) PCT Filed: Sep. 28, 2007
(86) PCT No.: PCT/EP07/60335

§ 371 Date: Apr. 17, 2009

(30) Foreign Application Priority Data
Nov. 2, 2006 (DE) 10 2006 051 778.4

(51) Int. Cl. G09G 5/00

(52) U.S. Cl. 345/632

(57) ABSTRACT

In a method and apparatus for displaying an x-ray image acquired in a mammographic examination wherein the breast was compressed to a compression thickness, a breast area of the breast in an image area of the x-ray image is determined, and the glandular density of the breast area is determined from brightness levels of the x-ray image in the image area and from the compression thickness. A value that characterizes the glandular density is displayed together with the x-ray image.

### BACKGROUND OF THE INVENTION

1. Field of the Invention

The present invention concerns a method and a device to display an x-ray image of a breast compressed to a compression thickness, the x-ray image being acquired in a mammography exam.

2. Description of the Prior Art

X-ray apparatuses for imaging the breast (normally of a female patient) are known. An imaging conducted with such an x-ray apparatus is designated as a mammogram. The breast is held or compressed in a retention or compression device. Normally two compression plates arranged parallel to one another are used for this purpose. The distance between the compression plates during the mammography is the compression thickness of the breast. An analog or digital image is produced by the x-ray apparatus by irradiating the breast with x-ray radiation. The resulting x-ray image is a projection of the breast. The image information in the x-ray image is the integral of the radiation-dependent x-ray attenuation coefficients over the path of the x-ray beam through the breast up to the x-ray radiation receiver (detector). The image information thus represents a sum.

In rough approximation, the breast tissue is composed of (radiographically less dense) fat and (radiographically dense) gland tissue. The qualitatively high-grade presentation or imaging of the dense tissue portion of the breast is a requirement in mammography. Due to the high x-ray absorption, less x-ray radiation arrives at the detector; high image noise or (for example) a particularly bright point results from this in the x-ray image. The image information or the image signal at such a point is thus severely noisy and contains less contrast than the imaging regions of the adipose tissue. The detection capability and diagnosis of lesions are hereby hindered. For example, a tumor situated under dense tissue can be poorly detected in the x-ray image, or not detected at all.

The proportion of dense tissue to the total tissue is also designated as glandularity. A high glandularity (thus a high proportion of dense tissue) represents a risk factor for the formation of breast cancer. The time curve of the glandularity (for example the variation of this between two mammograms) can be used by the physician for the diagnosis.

### SUMMARY OF THE INVENTION

An object of the present invention is to provide an improved method and an improved device for the display of an x-ray image acquired in a mammogram.

The invention is based on the realization that, with regard to the evaluation of the gland density, the presentation of the x-ray image is insufficient, and therefore information about the density or gland density of the breast are provided to the viewer of a mammogram, in particular a digital mammogram.

The above object is achieved by a method for the display of an x-ray image of a breast compressed to a compression thickness, the x-ray image being acquired in a mammogram, in which method:
a breast region of the breast that is imaged in the image region is defined for an image region of the x-ray image,
the gland density of the breast region is determined from the brightness values of the x-ray image in the image region and from the compression thickness, and
a characteristic value characterizing the gland density is displayed with the x-ray image.

The image region is, for example, an image region which particularly interests the viewer of the x-ray image (for example the physician conducting the mammogram), or is an established partial region of the x-ray image, for example when the x-ray image is subdivided into sub-regions by a grid or the like. The volume region of the breast that is finally imaged in the image region is then defined from the known imaging geometry of the x-ray system used to generate the x-ray image.

The determination of the gland density in the appertaining breast region is then conducted. Models and methods exist which attempt to determine the density or, respectively, gland density of tissue in the breast.

A phantom for density measurement is known from J. Diffey et al., “A new step-wedge for volumetric measurement of mammographic density”, IDWM 2006, LNCS 4096, 1-9, 2006, eds: S. M. Astley et al., Springer-Verlag Berlin, Heidelberg.

R. Highnam et al., “A representation for mammographic image processing”, Med. Image Anal., Vol. 1, 1-18, 1996 describes a theoretical approach for breast density determination.

Determining the breast density by comparison with reference materials is known from US 2002181651 A1.

These known models and methods are essentially used to physically understand the image generation process of the x-ray image with given gland density and to improve image processing methods for the x-ray image.

In the present method, the gland density is calculated from the x-ray image and provided to the finder/observer.

According to the invention, a parameter characterizing the gland density is displayed together with the x-ray image. The display of the x-ray image ensues at a finding workstation, for example; the display of the gland density or of the corresponding parameter ensues on a separate display, for example. The observer of the x-ray image thus receives information about the gland density of the presented breast or, respectively, of the portion in the image region. Since the parameter is normally indicated in the form of a numerical value, the physician receives definitive, objective and comparable statements about the gland density in the breast region. The aforementioned time curve of the gland density during a diagnosis between two mammograms is number-based and can be objectively verified.

Since the gland density is displayed directly together with the x-ray image, the viewer or, respectively, the finder directly receives the density information simultaneously. This is an assistance in the diagnosis finding and in the optimization of the workflow on patients. For example, given a critical finding an immediate follow-up examination or other workflow steps can be immediately introduced without the patient having to make another appointment at a practice or clinic at a later point in time.

The image region can be a single pixel of the x-ray image. Information about the gland density is thus also provided to the viewer of the x-ray image at maximum resolution, i.e. for every single image pixel of the x-ray image. The physician thus receives maximum detailed local information about the distribution of the gland density in the imaged breast. The image region can also be the entire image of the breast in the x-ray image. For example, a numerical value averaged over the entire breast can be created for the characteristic parameter or, respectively, gland density.

The determined gland density or, respectively, characteristic parameter can in turn additionally be used in a method according to the invention in order to automatically segment a region of interest (ROI) in the x-ray image using the determined gland density. For this purpose, it is appropriate to conduct the calculation of the gland density in advance for every single image pixel in the x-ray image. The ROI can then be segmented using a threshold for the gland density, for example, in that image regions (in particular pixels, for example) contribute to the ROI if their gland density lies above a threshold. Glandular tissue (thus tissue with high glandularity above the threshold) is thus segmented (thus marked) in the x-ray image.

If the x-ray image is displayed on a screen, the gland density can be indicated by selecting the image region in the x-ray image on the screen. For example, the user can execute a mouse click on a specific image region in order to display the gland density, or this can be automatically displayed as context information (for example in what is known as a “mouse over” function).

Gland density and x-ray image can be displayed together on a screen. The physician thus merely needs to observe the x-ray image and not a separate display in order to be informed about the gland density in the image region.

The gland density can be displayed as a glandularity value between “0%” and “100%”. The glandularity between “0” and “1” or “0%” and “100%” is a generally common characteristic value and thus is trusted by a broad group of observers.

The gland density can also be indicated as a value between “1” and “4”, according to the Breast Imaging Reporting and Data System (ACR BIRADS). This classification system for gland density is also widely known and thus is trusted by a broad group of image observers of x-ray images.

The determined value of the gland density in the image region can furthermore be used in order to implement a respective different image post-processing of the x-ray image in the image region, dependent on the image region. Interesting or suspicious image regions can thus automatically be presented in an improved manner via image processing so that a manual post-processing of the image that is otherwise necessary is conducted automatically at particularly interesting points.

The x-ray image may have been acquired as a pre-exposure for a follow-up acquisition. An acquisition parameter for the follow-up examination acquisition can thus be determined dependent on the gland density in the image region. Corresponding parameters are, for example, x-ray parameters such as aperture diaphragm, acceleration voltage, anode current, diaphragm characteristic or the like. The follow-up acquisition is thus optimized depending on the gland density. An additional optimized follow-up acquisition is thus superfluous, which leads to a dose savings with regard to the patient.

The determined gland density can be stored in a DICOM header (Digital Imaging and Communications in Medicine) of the x-ray image. The determined gland density is thus stored in a retrievable manner with the image and is always available for follow-up evaluation, documentation etc.

As already mentioned, a workflow specification for an additional workflow with regard to mammography can be determined depending on the determined gland density. For example, depending on the gland density the patient can be automatically scheduled for a follow-up examination at a determined later point in time, a personal planning for follow-up examinations can ensue, a billing for services can be initiated or the like.

The above object of the invention also is achieved by a device to display an x-ray image of a breast compressed to a compression thickness (which x-ray image was acquired in a mammogram), having a control and evaluation unit that defines a breast region of the breast that is imaged in an image region of the x-ray image, and that determines the gland density of the breast region from the brightness values of the x-ray image in the image region and from the compression thickness, and having a display unit to display a parameter characterizing the gland density together with the x-ray image. The control and evaluation unit is, for example, the central processor of an acquisition workstation or the like; the display unit is a display or monitor as described above.

The device according to the invention exhibits advantages comparable to those described above in connection with the method according to the invention.

The device can possess an interface for communication with a CAD processor (Computer Aided Detection/Diagnosis). Such a CAD processors then implements an aforementioned computer-aided diagnosis on the x-ray image or, respectively, based on the gland density in order to automatically determine or, respectively, segment the aforementioned ROI in the x-ray image.

The device can possess an interface for communication with a Radiology Information System (RIS). In particular, the device can hereby communicate with the RIS with regard to the aforementioned workflow steps or, respectively, store information about the gland density (for example the characteristic parameter) in a DICOM header of the x-ray image.

The device can have an interface for communication with a medical workflow system in order to initiate the aforementioned workflow steps.

### BRIEF DESCRIPTION OF THE DRAWINGS

FIG. 1 illustrates a breast in a compression device during a mammography examination.

FIG. 2 schematically illustrates a mammography system having a compression device as shown in FIG. 1.

FIG. 3 illustrates a stepped phantom for calibration of the mammography system of FIG. 2.

FIG. 3b illustrates a continuous phantom for calibration of the mammography system of FIG. 2.

FIG. 4 shows an x-ray image of the breast of FIG. 1, generated with the mammography system according to FIG. 2.

### DESCRIPTION OF THE PREFERRED EMBODIMENTS

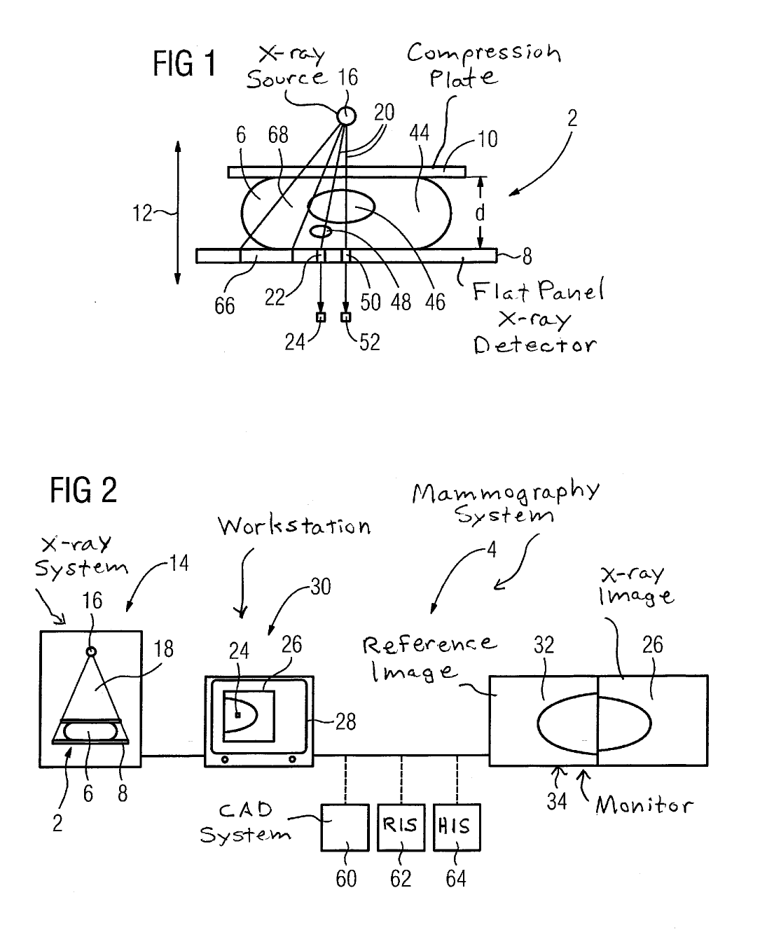

FIG. 1 shows a compression device 2 in a mammography system 4 shown in FIG. 2. A breast 6 of a patient (not shown) is inserted into the compression device 2. The compression device 2 has a 2D flat panel x-ray detector 8 that, in FIG. 1, is arranged perpendicular to the plane of the drawing and a compression plate 10 mounted parallel to this. The flat panel x-ray detector 8 and the compression plate 10 can be moved in the direction of the arrow 12 perpendicular to its planar extension plane so that the compression density d varies as the distance between these components. The breast 6 situated between the compression plate 10 and the flat panel x-ray detector 8 is therefore compressed to the compression thickness d.

The compression device 2 is part of an x-ray system 14 of the mammography system 4 according FIG. 2. The x-ray system 14 has an x-ray source 16 for emission of x-ray radiation 18 in the direction of the compression device 2 and the flat panel x-ray detector 8.

A single x-ray beam 20 emitted from the x-ray source 16 is shown a an example in FIG. 1, which x-ray beam 20 penetrates the compression plate 10 and the breast 6 and finally is received at the flat panel x-ray detector 8. There it strikes a detector cell 22 which in turn supplies a pixel 24 of the x-ray image 26 acquired with the flat panel x-ray detector 8, which is shown in FIG. 2 on the screen 28 of an acquisition workstation 30 of the mammography system 4. Moreover, in the mammography system 4 the x-ray image 26 is displayed together with a reference image 32 (not explained in detail) on a high-quality finding monitor 34 that is likewise part of the mammography system 4.

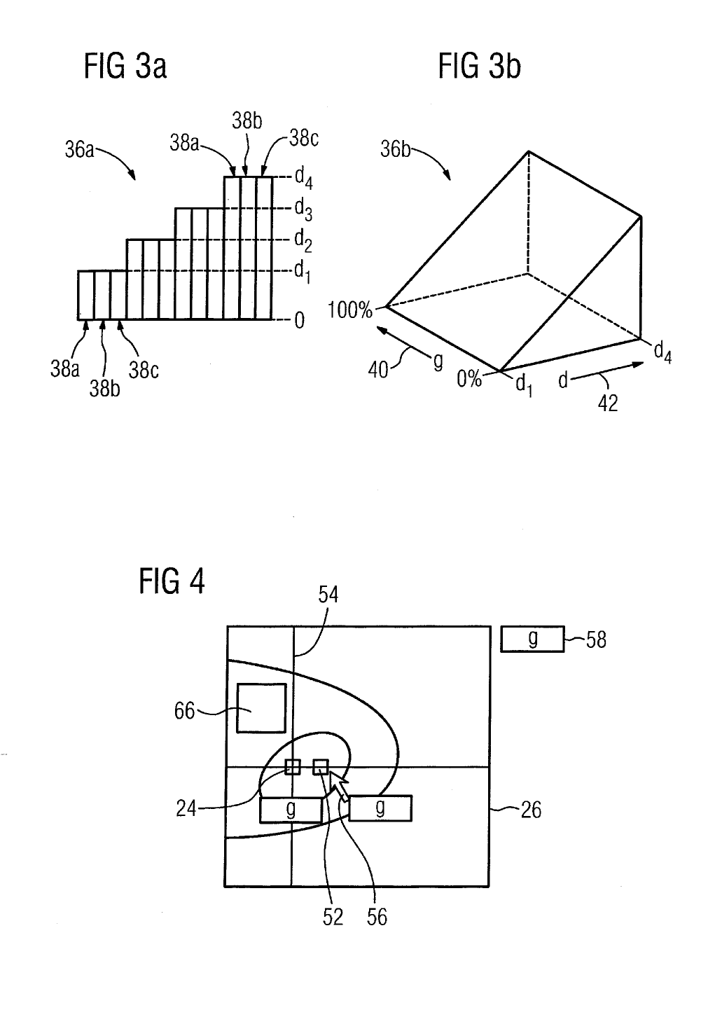

The x-ray system 14 is calibrated before a mammogram of the breast 6 (shown in FIG. 1) is conducted. For this, instead of the breast 6 a phantom 36a according to FIG. 3a or a phantom 36b according to FIG. 3b is inserted between compression plate 10 and flat panel x-ray detector 8. The phantom 36a possesses has different d₁-d₄ which respectively correspond to different compression thicknesses d according to FIG. 1 for the breast 6 that can be achieved with the compression device 2. For each thickness d₁-d₄, the phantom 36a respectively possesses three sections 38a-c which respectively simulate a different glandular composition of a breast 6. The section 38a exhibits a glandularity of 20%, i.e. a proportion of 20% and 80% of adipose tissue proportion. Section 38b is 50% glandular and 50% adipose, section 38c 80% glandular and 20% adipose. The phantom 36a thus possesses respective varying thicknesses of breast tissue phantoms of varying composition.

An x-ray image (not shown) of the phantom 36a is generated. In this x-ray image the various sections 38a-c of varying thicknesses d₁-d₄ produce varying pixel values. Given a known compression thickness d, it is hereby possible to later deduce the glandularity g of the imaged tissue of the breast 6 from a given pixel value. This procedure is conducted for each beam quality (anode, filter, voltage) that can be adjusted with the x-ray system 14.

Alternatively, for example, a phantom 36b according to FIG. 3b which—in contrast to the phantom 36a—is designed to be stepless can also be used. The material composition in the phantom 36b is selected so that, in the direction of the arrow 40, the glandularity rises from 0 to 100%, and the compression thickness d continuously increases from the value d₁ to the value d₄ in direction 42. In contrast to the phantom 36a, a continuous calibration of the mammography system 4 with regard to compression thickness d and glandularity g is therefore possible via the previously described calibration with the phantom 36b.

FIG. 4 shows the x-ray image 26 from FIG. 2 of the breast from FIG. 1 in detail. The grayscale value of the pixel 24 is composed from the attenuation of the x-ray beam 20 in the breast 6 along a path 43 (to the region of the breast 6 belonging to the pixel 24) through adipose tissue 44 (glandularity g=“0”), glandular tissue 46 (glandularity g=“1” or, respectively, 100%) and a tumor 48.

An additional x-ray beam 20 that falls on a detector cell 50 and produces a pixel 52 in the image does not run through the tumor 48. Although the pixel value of the pixel 52 is different from that of the pixel 24, the brightness differences are so slight that this is detectable neither on the screen 28 nor on the finding monitor 34.

However, since the glandularity g of the breast 6 is determined according to the calibration according to FIG. 3a or 3b for the pixels 24 and 52, these values are different. The corresponding glandularity values g are indicated in the x-ray image 26 to an observer of the image (thus the physician conducting the mammogram; not shown), for example at the acquisition workstation 30 or on a finding monitor 34. The glandularity thus itself represents the parameter according to the invention. Alternatively, the ACR BIRADS value “1”-“4” corresponding to the glandularity g is indicated.

The display ensues in that the physician moves a crosshair 54 to the corresponding image position or approaches the corresponding point in the image 26 with a computer mouse or, respectively, its mouse pointer 56. Since the glandularity values of the pixels 24 and 52 differ, in spite of occlusion by the tissue 46 the physician can diagnose the tumor 48.

Alternatively, the glandularity value can also be displayed on a display 58 next to the x-ray image 26. The glandularity value g can also be transferred from the mammography system 4 (for example at a CAD system 60) to an RIS 62 or an HIS 64 (Hospital Information System) in order to conduct a computer-aided finding, an additional processing of the glandularity g or its storage thereof, or a workflow control with regard to the mammographed patient.

Alternatively, according to FIG. 4 the glandularity 4 can also be determined for an image region 66 in the x-ray image 26, which image region 66 composed of multiple pixels.

The glandularity value g then corresponds not only to the glandularity g in the direct path of the x-ray beam 20 in FIG. 1 but rather to an entire volume region 68 of the breast 6 which is radioscoped with x-ray radiation 20 by the x-ray source 16 to generate the image region 60.

Although modifications and changes may be suggested by those skilled in the art, it is the intention of the inventors to embody within the patent warranted heron all changes and modifications as reasonably and properly come within the scope of their contribution to the art.

1.-18. (canceled)

19. A method for displaying an x-ray image of a breast acquired in a mammographic exam, comprising the steps of:
displaying an x-ray image of a breast acquired in a mammographic examination wherein the breast was compressed to a compression thickness, said x-ray image comprising an image region and, in said image region, defining a breast region of the breast;
in a processor, automatically determining the gland density of the breast region from brightness values of the x-ray image in the image region and from the compression thickness; and
from the processor, automatically causing a parameter that characterizes the gland density to be displayed with the x-ray image.

20. A method as claimed in claim 19 comprising employing a pixel of the x-ray image as said image region.

21. A method as claimed in claim 19 comprising employing an entirety of the image of the breast in the x-ray image as said image region.

22. A method as claimed in claim 19 comprising automatically segmenting a region of interest in the x-ray image using the determined gland density.

23. A method as claimed in claim 22 comprising segmenting the region of interest using a threshold for the gland density.

24. A method as claimed in claim 19 comprising displaying the x-ray image on a display screen in which the gland density is indicated by selecting the image region.

25. A method as claimed in claim 19 comprising displaying the gland density and the x-ray image together on a single display screen.

26. A method as claimed in claim 19 comprising displaying the gland density as a numerical glandularity value between 0% and 100%.

27. A method as claimed in claim 19 comprising displaying the gland density as a BI-RADS value between 1 and 4.

28. A method as claimed in claim 19 comprising post-processing said x-ray image in said image region differently depending on the gland density determined for that image region.

29. A method as claimed in claim 19 comprising CAD processing said x-ray image in said image region differently depending on the gland density determined for that image region.

30. A method as claimed in claim 19 comprising acquiring the x-ray image as a pre-exposure in a follow-up examination, and acquiring an image acquisition parameter for implementing said follow-up acquisition depending on said gland density in said image region.

31. A method as claimed in claim 19 comprising storing the determined gland density in a DICOM header of the x-ray image.

32. A method as claimed in claim 19 comprising automatically determining a workflow specification for a subsequent workflow for a mammographic examination of the breast depending on the determined gland density.

33. A device for displaying an x-ray image of a breast acquired in a mammographic exam, comprising:
a processor;
a display connected to said processor at which said processor causes an x-ray image of a breast acquired in a mammographic examination, wherein the breast was compressed to a compression thickness, to be displayed, said x-ray image comprising an image region;
an input unit connected to said processor allowing a breast region of the breast in said image region to be defined;
said processor being configured to automatically determine the gland density of the breast region from brightness values of the x-ray image in the image region and from the compression thickness; and
said processor being configured to automatically cause a parameter that characterizes the gland density to be displayed with the x-ray image.

34. A device as claimed in claim 33 comprising an interface for communication with a CAD processor.

35. A device as claimed in claim 33 comprising an interface for communication with an RIS.

36. A device as claimed in claim 33 comprising an interface for communication with a medical workflow system.
